(19) United States
(12) Patent Application Publication
(10) Pub. No.: US 2016/0341878 A1
(43) Pub. Date: Nov. 24, 2016

(54) Light Guide Plate and Backlight Module Having the Same

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/423,109

(22) PCT Filed: Jan. 9, 2015
(86) PCT No.: PCT/CN2015/070477

§ 371 Date: Feb. 20, 2015

(30) Foreign Application Priority Data
Nov. 7, 2014 (CN) 201410624156.7

(51) Int. Cl. F21V 8/00

(52) U.S. Cl. CPC G02B 6/0031; G02B 6/0016

(57) ABSTRACT

The disclosure is related to a light guide plate, comprising a first side, a second side opposite to the first side, a third side, and a light-entering side opposite to the third side; wherein each of the first side, the second side and the third side is provided with a reflector structure respectively. The disclosure is further related to a backlight module comprising the light guide plate. The reflector structures reflect the light into the light guide plate when the light is indicent to the side having the reflector structures from the light-entering side. The light guide plate increases the light utilization efficiency without causing the bright band appearing at the side of light guide plate at the same time and thereby increases the emitted light uniformity of the backlight module.

### BACKGROUND

1. Technical Field

The disclosure is related to liquid crystal display technology field, and more particular to a light guide plate and backlight module having the light guide plate.

2. Related Art

The liquid crystal displays are widely used in laptops, mobile phones, electronic dictionaries and other electronic display devices because of the advantages like thinness, low power consumption and low radiation. In recent years, the operation environments have changed because of the technical improvement on LCD technology filed. People desire to develop a LCD device with higher brightness due to the increasing visual demand under the situation that the frequency of outdoor usage is growing.

The light utilization efficiency needs to be improved for this reason. Among components of the backlight module, the light guide plate (LGP) plays an important role for increasing the light utilization efficiency of the backlight module. In order to increase the light utilization efficiency of backlight module, the current design of light guide plate adopts polish on the side of light guide plate. However, this design causes the bright band which appears at the side of light guide plate and thereby reduces the emitted light uniformity of the backlight module.

### SUMMARY

In order to solve the problem existing in the current technology, one embodiment of the disclosure provides a light guide plate, comprising: a first side; a second side opposite to the first side; a third side; and a light-entering side opposite to the third side; wherein each of the first side, the second side and the third side is provided with a reflector structure respectively.

In one embodiment, the reflector structures are V-shaped protrusions parallel to each other and continuously distributed.

In one embodiment, the V-shaped protrusions are asymmetric V-shaped protrusions or symmetric V-shaped protrusions.

In one embodiment, the reflector structures are dots in spacing arrays.

In one embodiment, the dots are circular concave grooves or convex cylinders.

Another embodiment of the disclosure provides a backlight module, comprising a light source; and a light guide plate comprising a first side; a second side opposite to the first side; a third side; and a light-entering side opposite to the third side; wherein the light source is arranged close to the light-entering side; wherein each of the first side, the second side and the third side is provided with a reflector structure respectively.

In one embodiment, the reflector structures are V-shaped protrusions parallel to each other and continuously distributed.

In one embodiment, the V-shaped protrusions are asymmetric V-shaped protrusions or symmetric V-shaped protrusions.

In one embodiment, the reflector structures are dots in spacing arrays.

In one embodiment, the dots are circular concave grooves or convex cylinders.

When the light is incident to the side arranged with the reflector structures from the light-entering side, the reflector structures reflect the light back to light guide plate. The light guide plate of the disclosure and the backlight module increase the light utilization efficiency and do not have the bright band appearing at the side of light guide plate at the same time and thereby increase the emitted light uniformity of backlight module.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the perspective view of the light guide plate according to the first embodiment of the present disclosure;

FIG. 2 is the top view of the light guide plate according to the first embodiment of the present disclosure;

FIG. 3 is the top view of the light guide plate according to the second embodiment of the present disclosure;

FIG. 4 is the front view of the first side of light guide plate according to the third embodiment of the disclosure;

FIG. 5 is the front view of the first side of light guide plate according to the fourth embodiment of the disclosure; and

FIG. 6 is the schematic of the light guide plate according to the first embodiment of the disclosure.

### DETAILED DESCRIPTION

The following description with reference to the accompanying drawings is provided to explain the exemplary embodiments of the disclosure. It will be apparent, however, that the disclosure may be practiced by one or more embodiments, and the specific embodiments provided herein cannot be interpreted to limit the disclosure. On the contrary, those embodiments are provided to explain the principle and the application of the disclosure such that those skilled in the art may understand the various embodiments of the disclosure and the various modifications for specific expected application.

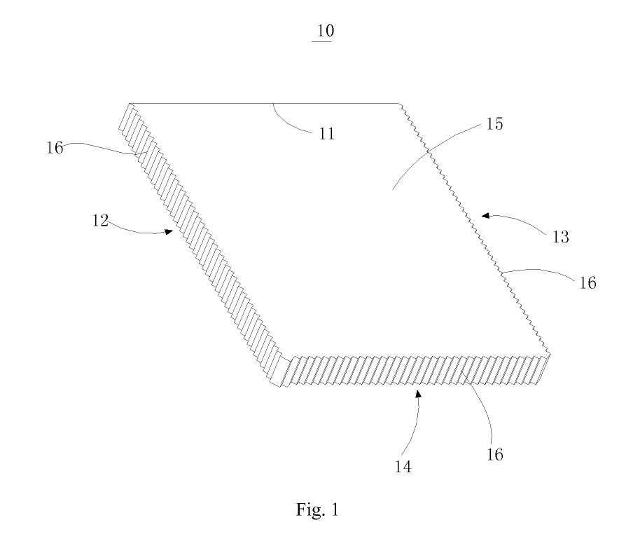

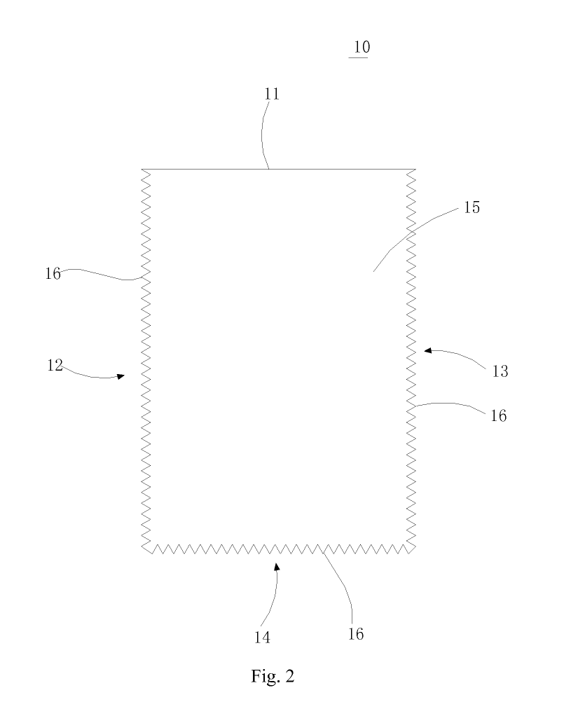

FIG. 1 is the perspective view of the light guide plate according to the first embodiment of the present disclosure. FIG. 2 is the top view of the light guide plate according to the first embodiment of the present disclosure.

With reference to FIG. 1 and FIG. 2, the light guide plate 10 according to the first embodiment of the disclosure comprises: a light-entering side 11, a first side 12, a second side 13, a third side 14, a light-emitting side 15 and a bottom side (not shown). The light-entering side 11 is opposite to the third side 14. The second side 13 is opposite to the first side 12. The light-emitting side 15 is opposite to the bottom side. Each of the first side 12, the second side 13 and the third side 14 is provided with a reflector structure respectively.

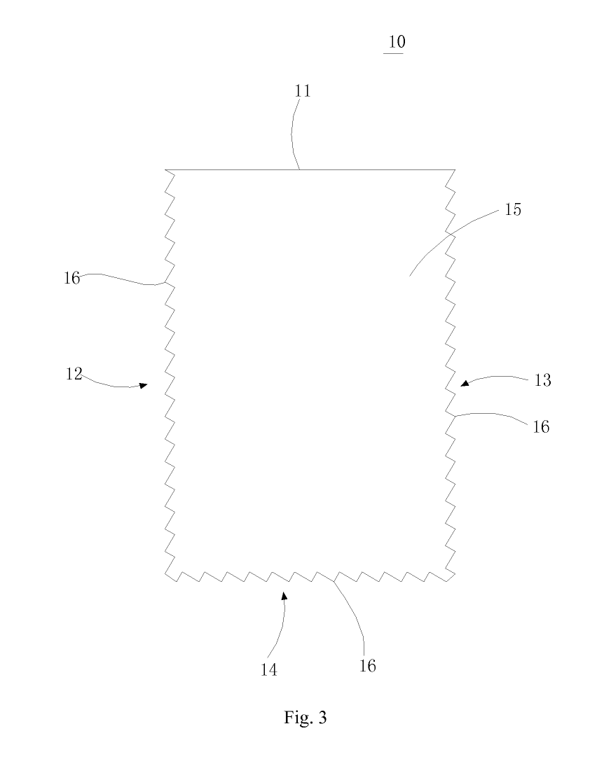

In the embodiment of the disclosure, the reflector structures 16 are V-shaped protrusions parallel to each other and continuously distributed, wherein the extension direction of the V-shaped protrusions 16 is perpendicular to the side which the protrusions 16 are arranged on. Further, the V-shaped protrusions 16 are symmetric V-shaped protrusions. With reference to FIG. 3, the V-shaped protrusions 16 are asymmetric V-shaped protrusions in another embodiment of the disclosure.

In addition, the bottom side of the light guide plate may be formed with a plurality of dots (not shown), to emit the indicent light from the light-emitting side 15.

After the light is indicent to the plurality of dots on the bottom side from the light-entering side 11, the direction of the incident light is changed by the plurality of dots such that the light may propagate forward toward the direction of the light-emitting side 15. When the light is indicent to the side formed with the V-shaped protrusions 16 from the light-entering side 11, the V-shaped protrusions 16 reflect the light to the light guide plate 10. The V-shaped protrusions 16 increase the light utilization efficiency without causing the bright band appearing at the side (i.e., the first side 12, the second side 13 and the third side 14) of the light guide plate at the same time.

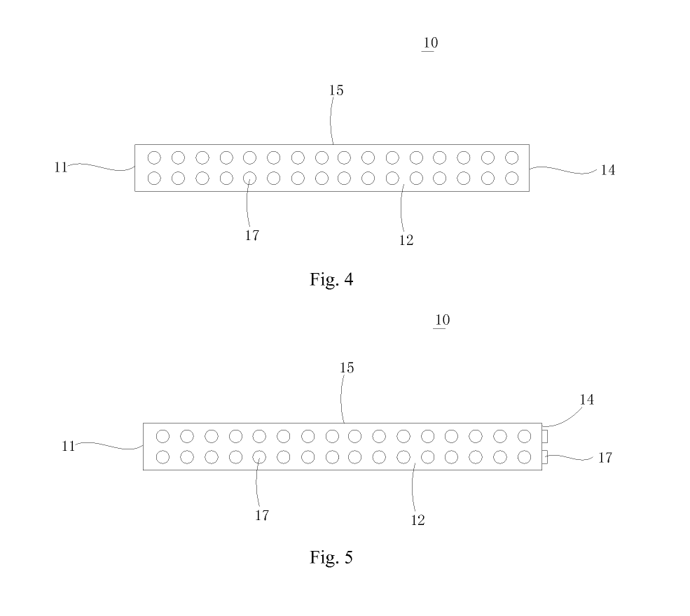

FIG. 4 is the front view of the first side of the light guide plate according to the third embodiment of the disclosure.

In the embodiment of the disclosure, the reflector structures are dots 17 distributed in spacing arrays. The extension direction of dots 17 is perpendicular to the the side which the dots 18 are arranged on. Further, the dots 17 are circular concave grooves. With reference to FIG. 5, the dots 17 are convex cylinders in another embodiment of the disclosure.

In addition, the bottom side of the light guide plate of the third embodiment of the disclosure may be formed with a plurality of dots (not shown) to emit the indicent light from the light-emitting side 15.

After the light is indicent to the plurality of dots on the bottom side from the light-entering side 11, the direction of the incident light is changed by the plurality of dots such that the light may propagate forward toward the direction of the light-emitting side 15. When the light is indicent to the side formed with the dots 17 from the light-entering side 11, the dots 17 reflect the light to the light guide plate 10. The dots 17 increase the light utilization efficiency without causing the bright band appearing at the side (i.e., the first side 12, the second side 13 and the third side 14) of the light guide plate at the same time.

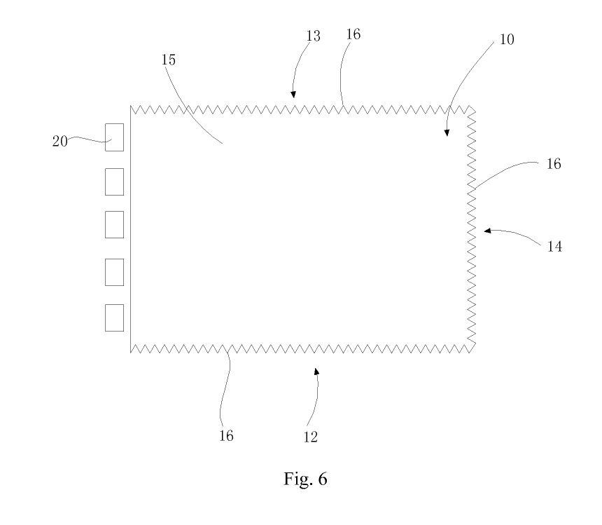

FIG. 6 is the schematic of the light guide plate according to the first embodiment of the disclosure.

With reference to 6, the backlight module of the first embodiment of the disclosure comprises: a light guide plate 10 and a plurality of light source 20.

The light guide plate 10 has substantially rectangular shape. The light guide plate 10 comprises the light-entering 11, the first side 12, the second side 13, the third side 14, the light-emitting side and the bottom side (not shown). The light-entering side 11 is opposite to the third side 14. The second side 13 is opposite to the first side 12. The light-emitting side 15 is opposite to the bottom side. Each of the first side 12, the second side 13 and the third side 14 is provided with a reflector structure respectively. The plurality of light source 20 is formed to face the light-entering side 11 and is spaced from each other. The light source 20 may be Light-Emitting Diodes in this embodiment.

In addition to the above components, the backlight module further comprises reflector sheets, diffusion sheets, prism sheets and brightness enhancing films etc. (not shown). The reflector sheets are close to the bottom side of the light guide 10. The diffusion sheets, the prism sheets, the brightness enhancing films are sequentially superimposed on the light-emitting side 15 of the light guide plate 10. These components are not discussed here because of well knowing to the skilled person.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A light guide plate, comprising:
a first side;
a second side opposite to the first side;
a third side; and
a light-entering side opposite to the third side;
wherein each of the first side, the second side and the third side is provided with a reflector structure respectively.

2. The light guide plate to claim 1, wherein the reflector structures are V-shaped protrusions parallel to each other and continuously distributed.

3. The light guide plate to claim 2, wherein the V-shaped protrusions are asymmetric V-shaped protrusions or symmetric V-shaped protrusions.

4. The light guide plate to claim 1, wherein the reflector structures are dots in spacing arrays.

5. The light guide plate to claim 1, wherein the dots are circular concave grooves or convex cylinders.

6. A backlight module, comprising:
a light source; and
a light guide plate comprising:
a first side;
a second side opposite to the first side;
a third side; and
a light-entering side opposite to the third side, wherein the light source is arranged close to the light-entering side;
wherein each of the first side, the second side and the third side is provided with a reflector structure respectively.

7. The backlight module to claim 6, wherein the reflector structures are V-shaped protrusions parallel to each other and continuously distributed

8. The backlight module to claim 7, wherein the V-shaped protrusions are asymmetric V-shaped protrusions or symmetric V-shaped protrusions.

9. The backlight module to claim 6, wherein the reflector structures are dots in spacing arrays.

10. The backlight module to claim 9, wherein the dots are circular concave grooves or convex cylinders.
